(19) United States
(12) Patent Application Publication
(10) Pub. No.: US 2024/0343319 A1
(43) Pub. Date: Oct. 17, 2024

(54) Lateral rear region of a motor vehicle comprising an air directing device, and motor vehicle

(71) Applicant: Dr. Ing. h.c. F. Porsche Aktiengesellschaft, Stuttgart (DE)

(72) Inventors: Dominik Beierl, Korntal-Münchingen (DE); Moritz Zeh, Stuttgart (DE)

(73) Assignee: Dr. Ing. h.c. F. Porsche Aktiengesellschaft, Stuttgart (DE)

(21) Appl. No.: 18/619,384

(22) Filed: Mar. 28, 2024

(30) Foreign Application Priority Data
Apr. 12, 2023 (DE) 102023109191.3
Apr. 12, 2023 (DE) 102023109208.1
Jul. 7, 2023 (DE) 102023117958.6

(51) Int. Cl. B62D 35/00

(52) U.S. Cl. CPC B62D 35/007

(57) ABSTRACT

A lateral rear region of a motor vehicle has a rear body member which extends at least behind a rear wheel housing of the motor vehicle, an air directing device, and an air guidance element of the air directing device. The air guidance element is displaceable relative to the rear body member between a rest position in which it is retracted into the lateral rear region and an operating position in which it is extended out of the lateral rear region in such a way that, in the retracted rest position of the air guidance element, a flow guide surface of the air guidance element is covered by the rear body member. In the extended operating position of the air guidance element, the flow guide surface of the air guidance element is displaced towards the rear, as seen in the longitudinal direction of the motor vehicle.

### CROSS-REFERENCE TO RELATED APPLICATIONS

This application claims priority to German Patent Application No. 10 2023 109 191.3, filed Apr. 12, 2023, German Patent Application No. 10 2023 109 208.1, filed Apr. 12, 2023, and German Patent Application No. 10 2023 117 958.6, filed Jul. 7, 2023, the contents of such applications being incorporated by reference herein in their entirety.

### FIELD OF THE INVENTION

The invention relates to a lateral rear region of a motor vehicle comprising an air directing device. The invention further relates to a motor vehicle.

### BACKGROUND OF THE INVENTION

A wide variety of motor vehicle air directing devices are known in practice. Air directing devices that are associated with a lateral region of a motor vehicle and used to guide flow in that location are also referred to as sideblades.

DE 10 2019 207 906 A1, which is incorporated by reference herein, discloses a motor vehicle having a sideblade which is arranged above a rear wheel, behind a window of a rear vehicle door.

DE 20 2011 005 504 U1, which is incorporated by reference herein, discloses a motor vehicle having an air directing element, which extends between a front wheel and a rear wheel and is used to guide flow in that location.

DE 10 2018 123 487 A1, which is incorporated by reference herein, discloses a motor vehicle comprising an air directing device designed as a wheel spoiler.

DE 10 2019 114 113 A1, DE 10 2007 003 601 A1 and FR 3 001 192 A1, which are incorporated by reference herein, disclose further related art.

### SUMMARY OF THE INVENTION

The invention relates to a lateral rear region of a motor vehicle comprising an air directing device that is used to guide flow in the lateral rear region behind a rear wheel housing of the motor vehicle. The invention is based on the task of creating a lateral rear region with an air directing device that enables a particularly advantageous flow guidance behind the rear wheel housing of the motor vehicle.

The lateral rear region of the motor vehicle according to aspects of the invention has a rear body member which extends at least behind a rear wheel housing of the motor vehicle. The lateral rear region of the motor vehicle according to aspects of the invention, also has an air directing device, an air guiding element of the air directing device being displaceable relative to the rear body member between a rest position in which it is retracted into the lateral rear region and an operating position in which it is extended out of the lateral rear region in such a way that, in the retracted rest position of the air guiding element, a flow guide surface of the air guiding element is covered by the rear body member, and that, in the extended operating position of the air guiding element, the flow guide surface of the air guiding element is displaced towards the rear, as seen in the longitudinal direction of the motor vehicle, on the one hand, and towards the outside, as seen in the transverse direction of the motor vehicle, on the other hand, compared with the retracted rest position. When the air guiding element of the air directing device is displaced into the retracted rest position, a flow guide surface of the air guiding element of the air directing device is retracted into the lateral rear region and covered by the rear body member. In the rest position, there is then no flow guiding via the air directing device. In the extended operating position, on the other hand, the air flow is guided behind the respective rear wheel housing of the lateral rear region with the aid of the air directing device, wherein the flow guide surface in the extended operating position is displaced rearwards in the longitudinal direction of the motor vehicle and outwards in the transverse direction of the motor vehicle compared with the retracted rest position. In the operating position of the air directing device, this allows a particularly advantageous flow guidance in the lateral rear region behind a respective rear wheel housing of the motor vehicle.

Preferably, in the extended operating position, the flow guide surface of the air guiding element extends flush with an outer surface of the rear body member that is directly adjacent to the flow guide surface at the front. This is particularly preferable for advantageous flow guiding in the extended operating position. The flush transition between the flow guide surface of the air guiding element and the outer surface of the rear body member, which is directly adjacent to the flow guide surface of the extended air guiding element at the front, allows a particularly advantageous flow around the flow guide surface when the air directing device is in the extended operating position.

Preferably, in addition to the displaceable air guiding element having the flow guide surface, the air directing device has a guide and drive unit which guides and drives the air guiding element during displacement relative to the rear body member. The guide and drive unit has at least one fixed guide rail and at least one sliding block that can be displaced relative to the fixed guide rail, wherein the air guiding element engages with at least one guide bolt in a guide groove of the respective guide rail and in at least one guide groove of the respective sliding block. The guide and drive unit also has a drive which displaces the respective sliding block relative to the respective guide rail and, via the respective sliding block, the air guiding element relative to the rear body member. The air guiding element can be displaced particularly advantageously between the retracted rest position and the extended operating position via the guide and drive unit. The interaction of the at least one fixed guide rail, the at least one sliding block and the at least one guide bolt allows easy displacement of the air guiding element and thus of the flow guide surface both in the longitudinal direction and in the transverse direction of the motor vehicle when it is displaced between the retracted rest position and the extended operating position. There is no risk of the air guiding element jamming during displacement.

Preferably, the guide groove of the respective guide rail has a first guide section for the displacement of the at least one guide bolt and thus of the air guiding element in the longitudinal direction or mainly in the longitudinal direction and at least one second guide section for the displacement of the at least one guide bolt and thus of the air guiding element in the transverse direction or mainly in the transverse direction, wherein the at least one guide groove of the at least one sliding block is curvedly contoured and extends obliquely to the guide sections of the respective guide rail. The guide sections of the guide groove of the respective guide rail and the respective guide groove of the respective slide rail allow the air guiding element to be displaced in the longitudinal and transverse direction of the motor vehicle in a particularly advantageous manner.

### BRIEF DESCRIPTION OF THE DRAWINGS

Preferred embodiments of the invention follow from the dependent claims and the subsequent description. Without being restricted thereto, exemplary embodiments of the invention will be explained in greater detail with reference to the drawings. Shown are:

FIGS. 1a, 1b show two views of a lateral rear region of a motor vehicle according to the present invention in a first state with an air directing device in a retracted resting position,

FIGS. 2a, 2b show two views of the lateral rear region of the motor vehicle according to aspects of the invention in a second state with an air directing device in an intermediate position between the retracted rest position and an extended operating position,

FIGS. 3a, 3b show two views of the lateral rear region of the motor vehicle according to aspects of the invention in a third state with an air guiding device in the extended operating position,

FIGS. 4a, 4b show two views of the air guiding device in the retracted rest position,

FIGS. 5a, 5b show two views of the air guiding device in the intermediate position,

FIGS. 6a, 6b show two views of the air guiding device in the extended operating position,

FIGS. 7a, 7b show two further views of the lateral rear region of the motor vehicle according aspects of to the invention in the retracted rest position and in the extended operating position to illustrate the flow guiding.

### DETAILED DESCRIPTION OF THE INVENTION

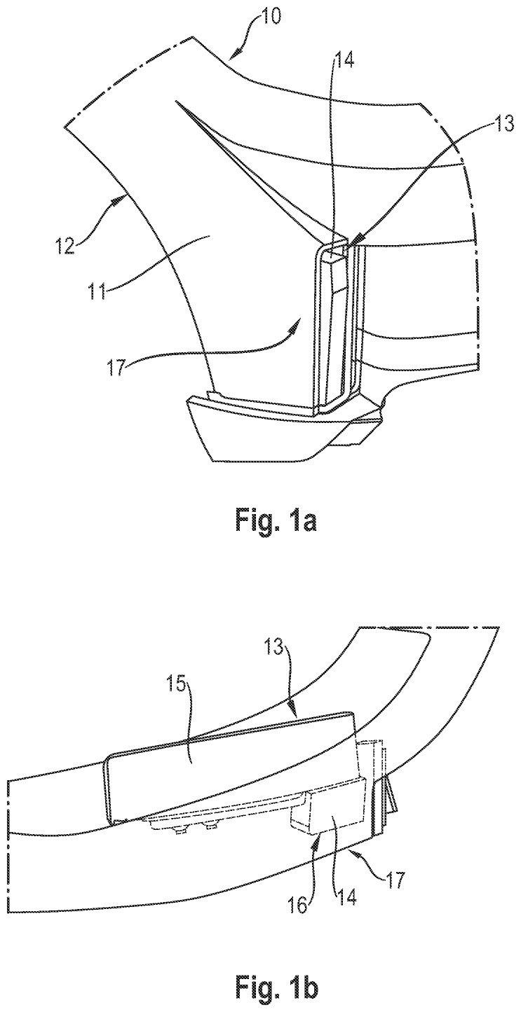

FIGS. 1a to 3b show a detail from a lateral rear region 10 of a motor vehicle according to aspects of the invention. From the lateral rear region 10, a rear body member 11 is shown that extends in the lateral rear region 10 of the motor vehicle at least behind a rear wheel house 12 of the motor vehicle.

Such a lateral rear region 10 is formed on both sides of the motor vehicle.

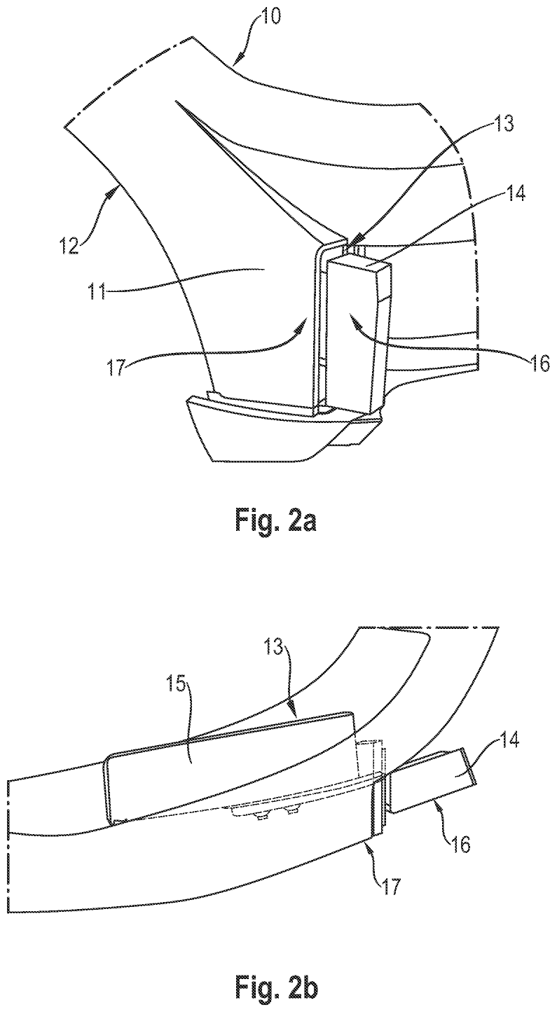

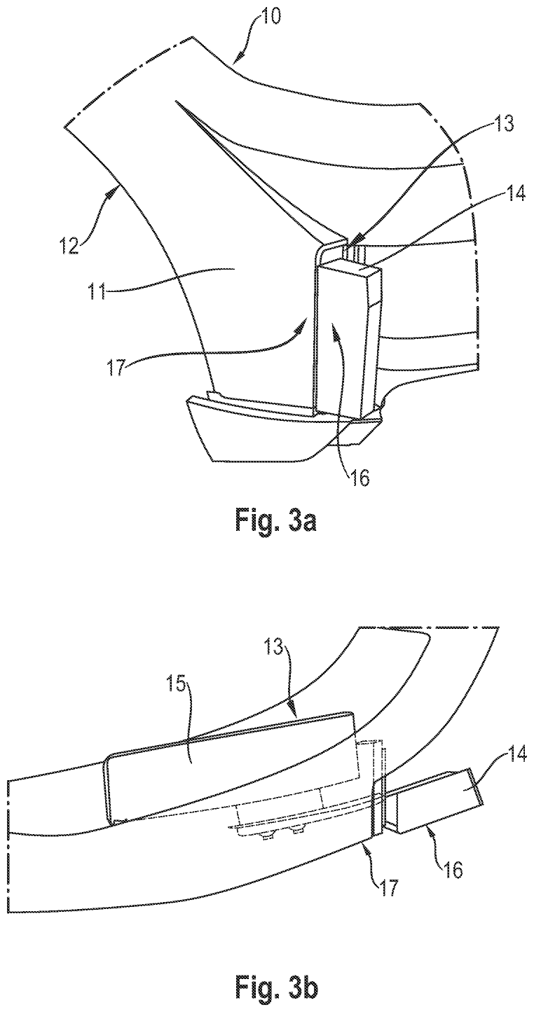

The lateral rear region 10 comprises an air directing device 13. The air directing device 13 comprises an air guidance element 14 as well as a guide and drive unit 15. By means of the guide and drive unit 15, the air guidance element 14 can be displaced relative to the rear body member 11 between a rest position retracted in the lateral rear region 10 (see FIGS. 1a, 1b) and an operating position extended from the same (see FIGS. 3a, 3b), whereby FIGS. 2a, 2b show an intermediate position of the air guidance element 14 between the retracted rest position in FIG. 1a, 1b and the retracted rest position in FIGS. 3a, 3b.

The guide and drive unit 15 is completely covered by the rear body member 11 and mounted in or at the lateral rear region 10 such that the guide and drive unit 15 is fixed to the rear body member 11. The air guidance element 14 is displaceable relative to the guide and drive unit 15 as well as relative to the rear body member 11.

The air guidance element 14 comprises a flow guide surface 16. In the retracted resting position (FIGS. 1a, 1b) of the air guidance element 14, the flow guide surface 16 thereof is retracted into the lateral rear region 10 and is covered by the rear body member 11. In the extended operating position (FIGS. 3a, 3b) of the air guidance element 14, the flow guide surface 16 thereof is extended out of the lateral rear region 10 and is not covered by the rear body member 11, the flow guide surface 16 of the air guidance element 14 in the extended operating position being displaced towards the rear as seen in the longitudinal direction of the motor vehicle on the one hand and towards the outside as seen in the transverse direction of the motor vehicle on the other hand, compared with the retracted rest position. In the intermediate position shown in FIGS. 2a, 2b, the flow guide surface 16 is only displaced rearward when viewed in the longitudinal direction of the motor vehicle. In the extended operating position (FIGS. 3a, 3b), the same is also displaced outwardly when viewed in the transverse direction of the motor vehicle.

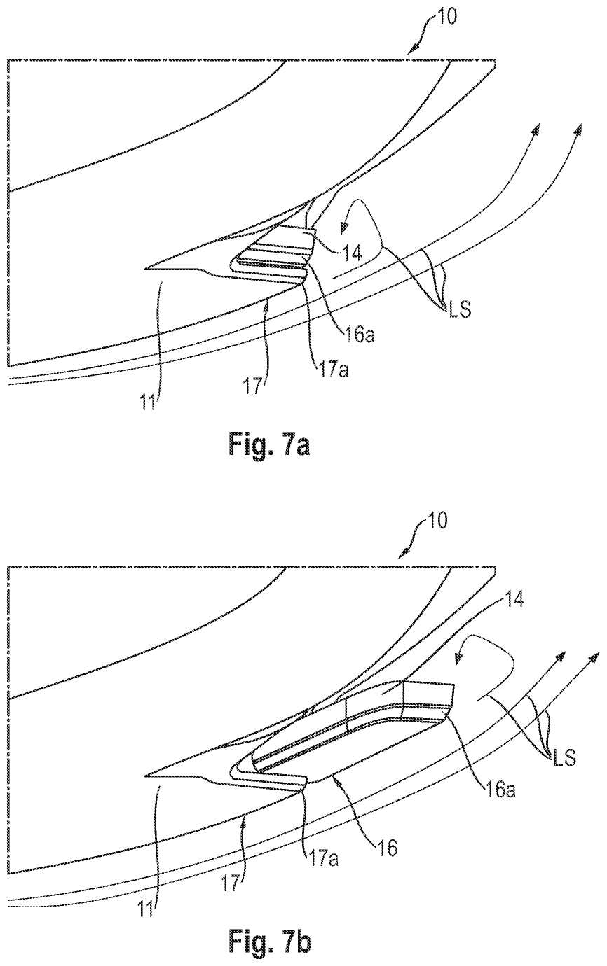

In the extended operating position of the air guidance element 14 (FIGS. 3a, 3b), the flow guide surface 16 of the air guidance element 14 is in particular displaced outwards when viewed in the transverse direction of the motor vehicle such that the same extends flush with an outer surface 17 of the rear body member 11, which is immediately connected to the flow guide surface 16 in the front. FIGS. 7a and 7b also show the air guidance element 14 of the air directing device 13 in two different states, namely in FIG. 7a in the retracted rest position and in FIG. 7b in the extended operating position, wherein FIG. 7b again shows the flush transition between the flow guide surface 16 of the air guidance element 14 extended into the operating position and the outer surface 17 of the rear body member 11 immediately adjacent to the front or in front of the same. Also shown in FIGS. 7a and 7b is an air flow LS in the region of the rear body member 11, i.e., in FIG. 7a an air flow LS in air guidance element 14 displaced to the retracted rest position and in FIG. 7b air guidance element 14 displaced to the extended operating position.

Whereas in FIG. 7a the air flow LS debonds in the region of an edge 17a of the outer surface 17 of the rear body member 11, in FIG. 7b this debonding of the air flow LS takes place in the region of an edge 16a of the flow guide surface 16 of the air guidance element 14. In FIG. 7a, this edge 16a of the flow guide surface 16 is occluded on the outside of the edge 17a of the outer surface 17 of the rear body member 11.

In the retracted rest position, the flow guide surface 16 of the air guidance element 14 is fully retracted into the lateral rear region 10 and is covered externally from the outer surface 17 of the rear body panel 11.

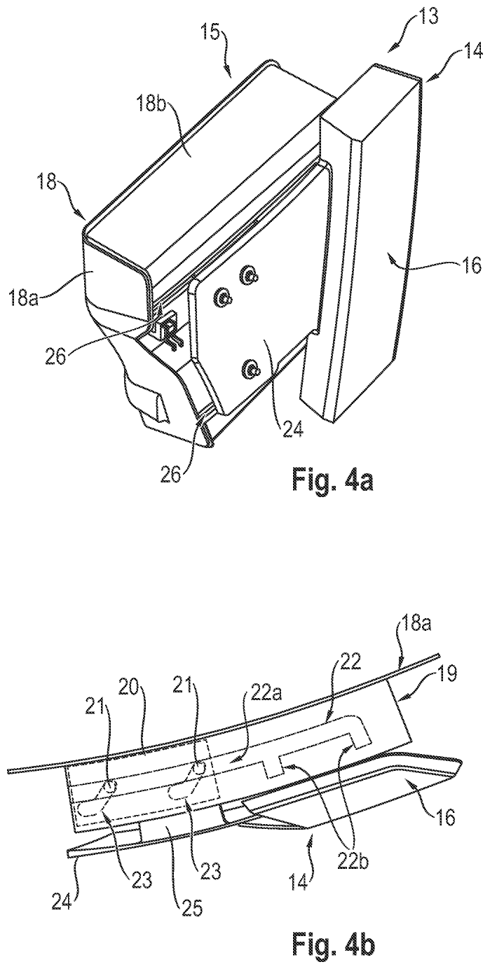

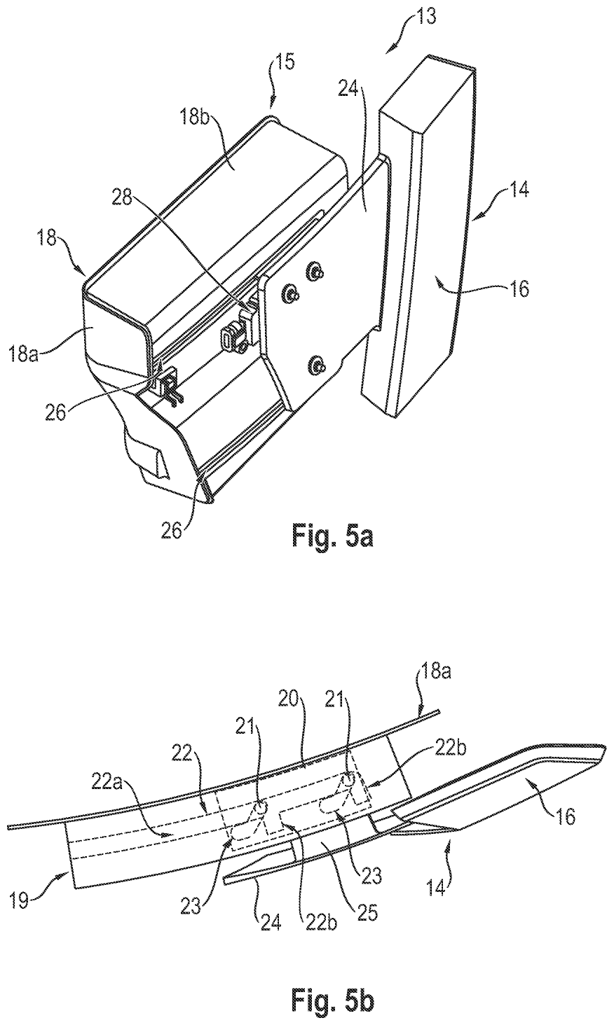

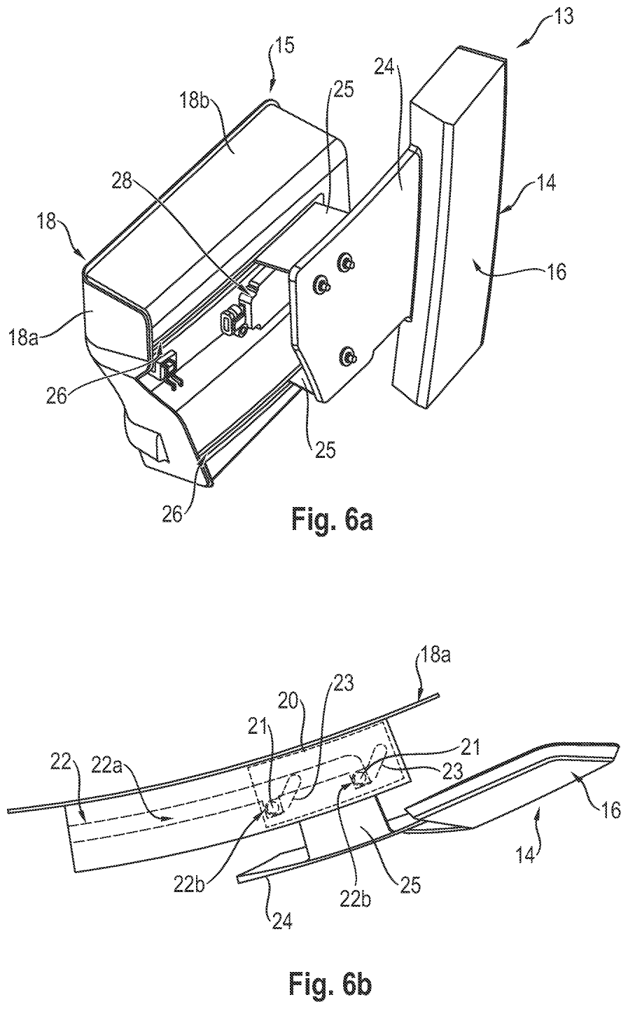

FIGS. 4a to 6b show further details of the air directing device 13 of the lateral rear region 10 according to aspects of the invention, whereas FIGS. 4a to 6b show the air directing device 13 in the sole representation, i.e., FIGS. 4a, 4b in the retracted rest position, FIGS. 6a, 6b in the extended operating position and FIGS. 5a, 5b in an intermediate position between the extended operating position and the extended operating position.

The guide and drive unit 15 of the air directing device 13, which is used to displace the air guidance element 14 between the retracted rest position and the extended operating position, has a housing 18 consisting of a first housing member 18a and a second housing member 18b. Both housing members 18a, 18b are respectively shown in FIGS. 4a, 5a, 6a. In FIGS. 4b, 5b, 6b, the respective second housing member 18b is not shown.

At least one fixed guide rail 19 of the guide and drive unit 15 is received in the housing 18. In particular, two such guide rails 19 are arranged in the housing 18, i.e., an upper fixed guide rail 19 and a lower fixed guide rail 19. In FIGS. 4b, 5b, 6b, the respective upper fixed guide rail 19 is visible.

A sliding block 20, which can be displaced relative to the respective fixed guide rail 19, cooperates with the respective fixed guide rail 19. The air guidance element 14 is guided with at least one guide bolt 21 on a respective guide rail 19 and on a respective sliding block 20.

Preferably, two upper guide bolts 21 of the air guidance element 14 cooperate with the upper fixed guide rail 19 and the upper sliding block 20. With the lower fixed guide rail 19 and the lower sliding block 20 (not visible in FIGS. 4b, 5b, 6b), a single lower guide bolt 21 of the air guidance element 14 preferably cooperates. The guide bolts 21 engage a guide groove 22 of the respective guide rail 19 and a respective guide groove 23 of the respective sliding block 20. Via a drive 28 of the guide and drive unit 15, the respective sliding block 20 can be displaced relative to the respective guide rail 19, and via the respective sliding block 20, the air guidance element 14 can be displaced relative to the rear body member 11.

If the air guidance element 14 is intended to be displaced from the retracted rest position of FIGS. 4a, 4b to the extended operating position of FIGS. 6a, 6b, the respective sliding block 20 is first translated along the respective guide rail 19, whereby the guide bolts 21 are or are to be displaced in a first guide section 22a of the respective guide groove 22 of the respective guide rail 19.

If the or one of the guide bolts 21 comes into contact with a limitation of this first guide section 22a of the guide groove 22 of the respective guide rail 19, the guide bolts 21 can or can no longer be displaced within the first guide section 22a. In this case, the air guidance element 14 then occupies the intermediate position in FIGS. 5a, 5b.

If the respective sliding block 20 is subsequently translationally displaced further relative to the respective guide rail 19, the guide bolt or guide bolts 21, which are also guided in the at least one guide groove 23 of the sliding block 20, is or are pressed via the respective sliding block 20, namely the at least one guide groove 23 thereof, into second guide sections 22b of the guide groove 22 of the respective guide rail 19, namely outwards in the transverse direction of the motor vehicle. This is caused by the curved contour of the at least one guide groove 23 of the respective sliding block 20, which is doubled in a curved manner and extends obliquely to the guide sections 22a, 22b of the guide groove 22 of the respective guide rail 19.

Thus, when displacing the air guidance element 14 from the retracted rest position shown in FIG. 4b to the extended operating position shown in FIG. 6b, the guide bolts 21 of the air guidance element 14 are first displaced along the first guide sections 22a of the guide grooves 22 of the guide rails 19 in the longitudinal direction or primarily in the longitudinal direction of the motor vehicle until this is not possible. In this case, the air guidance element 14 then occupies the intermediate position of FIG. 5b and is displaced rearward in the longitudinal direction of the vehicle. The first guide portions 22a of the guide grooves 22 of the guide rails 19 extend in the longitudinal direction or primarily in the longitudinal direction of the motor vehicle. The same can include an acute angle of up to 15° or up to 10° or up to 5° with the longitudinal direction of the motor vehicle. By further relative movement of the respective sliding block 20 rearward with respect to the respective guide rail 19, the guide bolts 21 are then moved along the guide grooves 23 of the sliding blocks 20, as well as moved outwards in the transverse direction of the motor vehicle and along the second guide sections 22b of the guide grooves 22 of the guide rails 19, which extend in the transverse direction of the motor vehicle, or mainly in the transverse direction of the motor vehicle. The air guidance element 14 is then transferred to the operating position of FIG. 6b. The second guide portions 22b are perpendicular to the first guide portions 22a.

The air directing device 13 or the air guidance element 14 comprises a tab 24, into which protrusions 25 engage. The tab 24 extends forwardly from the air guidance element 14 in the longitudinal vehicle direction, is displaceable together with the air guidance element 14 and is always covered by the rear body member 11. The tab 24 is a “part” of the air guidance element 14, but does not provide the flow guide surface 16 of the air guidance element 14. The protrusions 25 extend in the transverse direction of the motor vehicle from the tab 24. The guide bolts 21 are formed or arranged on the protrusions 25. The protrusions 25 and guide bolts 21 are also “components” of the air guidance element 14.

The protrusions 25 extend into the housing 18 starting from a side of the tab 24 facing away from the flow guide surface 16 with portions through slots 26 in the housing member 18b. The guide bolts 21 are formed or arranged on the portions of these protrusions 25 positioned in the housing 18.

A superimposed double guide is provided via the interaction of the respective guide rail 19 with the respective sliding block 20. Firstly, displacement is performed in the longitudinal direction or primarily in the longitudinal direction, then displacement is performed in the transverse direction or primarily in the transverse direction.

What is claimed is:

1. A lateral rear region of a motor vehicle, said lateral rear region comprising:
a rear body member which extends at least partially behind a rear wheel housing of the motor vehicle; and
an air directing device having an air guidance element, the air guidance element being displaceable relative to the rear body member between:
(i) a rest position, wherein in the rest position of the air guidance element, the air guidance element is retracted into the lateral rear region and a flow guide surface of the air guidance element is covered by the rear body member, and
(ii) an operating position, wherein in the operating position of the air guidance element the air guidance element is extended out of the lateral rear region, wherein as compared to the rest position, in the operating position of the air guidance element, the flow guide surface of the air guidance element is (a) displaced rearwardly as seen in a longitudinal direction of the motor vehicle and (b) displaced to an outside of the motor vehicle as seen in a transverse direction of the motor vehicle.

2. The lateral rear region according to claim 1, wherein, in the operating position of the air guidance element, a front surface of the flow guide surface of the air guidance element extends flush with an outer surface of the rear body member directly adjoining the flow guide surface of the air guidance element.

3. The lateral rear region according to claim 1, wherein, in the rest position of the air guidance element, the flow guide surface of the air guidance element is completely retracted into the lateral rear region.

4. The lateral rear region according to claim 1, wherein the air directing device further comprises a guide and drive unit which guides and drives the air guidance element during the displacement relative to the rear body member.

5. The lateral rear region according to claim 4, wherein the guide and drive unit has at least one fixed guide rail and at least one sliding block which is configured to be displaced relative to the fixed guide rail, the air guidance element engaging with at least one guide bolt in a guide groove of the fixed guide rail and in at least one guide groove of the sliding block.

6. The lateral rear region according to claim 5, wherein the guide and drive unit includes a drive which displaces (i) the sliding block relative to the guide rail and (ii) the air guidance element relative to the rear body member via the sliding block.

7. The lateral rear region according to claim 5, wherein the guide groove of the respective guide rail has a first guide section for displacing the at least one guide bolt, and thus the air guidance element of the air directing device, in the longitudinal direction or mainly in the longitudinal direction of the rear region or of the motor vehicle and at least one second guide section for the displacement of the at least one guide bolt, and thus of the air guidance element of the air directing device, in the transverse direction or mainly in the transverse direction of the rear region or of the motor vehicle.

8. The lateral rear region according to claim 7, wherein the at least one guide groove of the sliding block is curvedly contoured and extends obliquely to the guide sections of the respective guide rail.

9. The lateral rear region according to claim 5, wherein the guide and drive unit comprises an upper fixed guide rail and a lower fixed guide rail, wherein a sliding block cooperates with each guide rail, and wherein two upper guide bolts are positioned within the guide grooves of the upper guide rail and the upper sliding block, and wherein a single lower guide bolt is positioned within the guide grooves of the lower guide rail and the lower sliding block.

10. The lateral rear region according to claim 5, wherein the guide and drive unit has a housing, the at least one fixed guide rail and the at least one sliding block being arranged in an interior of the housing, wherein protrusions of the air guidance element extend from a side of the air guidance element facing away from the flow guide surface with portions through slots in the housing into the housing, and wherein the guide bolts of the air guidance element are formed or arranged on the portions of the protrusions of the air guidance element arranged in the housing.

11. A motor vehicle having two lateral rear regions according to claim 1.
